(19) United States
(12) Patent Application Publication
(10) Pub. No.: US 2007/0214704 A1
(43) Pub. Date: Sep. 20, 2007

(54) Fish strike indicating apparatus

(76) Inventor: Joseph M. Wicinski, Staten Island, NY (US)

Correspondence Address: Joseph M. Wicinski, 275 Barnard Ave., Staten Island, NY, 10307, US

(21) Appl. No.: 11/384,553

(22) Filed: Mar. 20, 2006

(51) Int. Cl. A01K 97/12

(52) U.S. Cl. 43/17

(57) ABSTRACT

A fish strike indicating apparatus is provided. The fish strike indicating apparatus includes a mounting unit for mounting on a fishing rod, the mounting unit including a first portion having a concave configuration, and a second portion having an elongated cavity insert; and an indicating unit for indicating movement of the fishing rod, the indicating unit including a clip for slidably coupling to the second portion via the elongated cavity insert.

### BACKGROUND OF THE INVENTION

1. Technical Field

The present invention relates to fishing equipment, and more particularly, to a fish strike indicating apparatus.

2. Discussion of the Related Art

Over the years, a variety of audible and visual signaling devices have been provided to indicate whether a fish has struck or taken a baited line. The attraction of such devices is that they allow a fisherman to fish while using a line which may be largely unattended, to fish while using several lines, or to fish at night.

One of the oldest of these devices is a mechanical signaling apparatus such as a bell or rattle secured to the tip of a fishing rod which is activated by the jerking movement of the rod tip when a fish strikes. Other signaling devices of increasing complexity have been developed to serve this function.

Typically, these devices utilize batteries as a power source and may include an audible or visual alarm and a structure for closing a switch in a circuit to activate the alarm. The alarm may be activated, for example, when a fishing pole on which it is located deviates from a relatively static position, when tension is exerted on the fishing line, or when the fishing line is moved in a linear manner such as that which occurs when a fish strikes or takes the bait.

Generally, the more complex bite detector devices fall into one of two categories. In one category are bite detectors that include some sort of level responsive switch. While in another category, are those devices that detect movement of the fishing line. For level detecting devices, a switch that is responsive to positional change is mounted to a fishing pole, and connected in series with a power source and an indicator such as a buzzer, light or both. For devices that detect movement of the fishing line, they tend to include a structure for closing a switch in a circuit to actuate an alarm when tension is exerted on the fishing line, or when the fishing line is moved when a fish strikes the hook or takes the bait.

Although such devices generally serve the purpose of informing a fisherman that a fish has struck or taken a baited line, they are typically removed prior to casting. In addition, after they have been illuminated, they must be manually turned off. Further, many of these devices need to be readjusted as the environment in which they are used changes, for example, due to an increase in water current or a changing tide.

### SUMMARY OF THE INVENTION

The present invention provides a fish strike indicating apparatus that can be affixed to a back or top side of a fishing rod, the apparatus indicating whether a fish has struck or taken a baited line by illuminating a light emitting element for a predetermined amount of time.

In one embodiment of the present invention, a fish strike indicating apparatus, comprises: a mounting unit for mounting on a fishing rod, the mounting unit including a first portion having a concave configuration, and a second portion having an elongated cavity insert; and an indicating unit for indicating movement of the fishing rod, the indicating unit including a clip for slidably coupling to the second portion via the elongated cavity insert.

The fish strike indicating apparatus further comprises a fastener for fastening the mounting unit to the fishing rod. The fastener is a tie. The mounting unit further comprises a first opening and a second opening for receiving the fastener. The indicating unit further comprises a housing, the housing comprises: a battery; a timer; a printed circuit; and a light emitting element.

The housing is cylindrical. The clip is affixed to the housing. The light emitting element is an LED, OLED or a light bulb. The housing further comprises a first portion and a second portion, the first portion for storing the battery, timer, printed circuit, and light emitting element, the second portion for displaying light emitted by the light emitting element. The first portion of the housing is coupled to the second portion of the housing via a coupling means.

In another embodiment of the present invention, a fish strike indicating apparatus for use with a fishing rod having a baited hook coupled to a fishing line comprises: a mounting unit for mounting on the fishing rod, the mounting unit including a first side having a concave configuration for connecting to a back side of the fishing rod, a second side having a cavity insert, and a pair of openings for receiving a fastener for fastening the mounting unit to the fishing rod; and an indicating unit for indicating movement of the fishing rod, the indicating unit including a clip for connecting to the second side via the cavity insert, and a light source for illuminating in response to movement of the fishing rod.

The mounting unit is formed of silicon or plastic. The indicating unit comprises: a spring connected to a power source, the power source connected to the light source, the light source disposed on a printed circuit board; a metal strip connected at one end between the spring and the power source and connected at another end to the printed circuit board; and a switch connected to the printed circuit board, the switch responsive to movement of the fishing rod to energize the light source. The power source is a battery. The light source is an LED, OLED or light bulb.

The indicating unit further comprises a timing circuit for controlling a rate at which the light source is energized, wherein the rate at which the light source is energized determines an amount of time the light source is illuminated. When the mounting unit is positioned near a reel on the fishing rod an amount of movement of the fishing rod needed for illuminating the light source is greater than an amount of movement of the fishing rod needed for illuminating the light source when the mounting unit is positioned near a tip of the fishing rod.

In yet another embodiment of the present invention, an apparatus for indicating movement of a fishing rod comprises: a mount for mounting on the fishing rod, the mount including a first portion contoured to fit to a top side of the fishing rod, and a second portion having a receptacle; and an indicator for indicating movement of the fishing rod, the indicator including a removable clip for connecting the indicator to the second portion via the receptacle. The indicator further comprises a light emitting element. The light emitting element emits light for a predetermined amount of time in response to movement of the fishing rod.

The foregoing features are of representative embodiments and are presented to assist in understanding the invention. It should be understood that they are not intended to be considered limitations on the invention as defined by the claims, or limitations on equivalents to the claims. Therefore, this summary of features should not be considered dispositive in determining equivalents. Additional features of the invention will become apparent in the following description, from the drawings and from the claims.

### BRIEF DESCRIPTION OF THE DRAWINGS

FIG. 1 is a fish strike indicating apparatus according to an exemplary embodiment of the present invention;

FIG. 2 is a fishing rod mount as shown in FIG. 1;

FIG. 3 is a fish strike indicator as shown in FIG. 1;

FIG. 4A is an exploded view of the fish strike indicator of FIG. 3;

FIG. 4B is a fish strike indicator according to an exemplary embodiment of the present invention; and

FIG. 5 is a fish strike indicator according to yet another exemplary embodiment of the present invention.

### DETAILED DESCRIPTION OF EXEMPLARY EMBODIMENTS

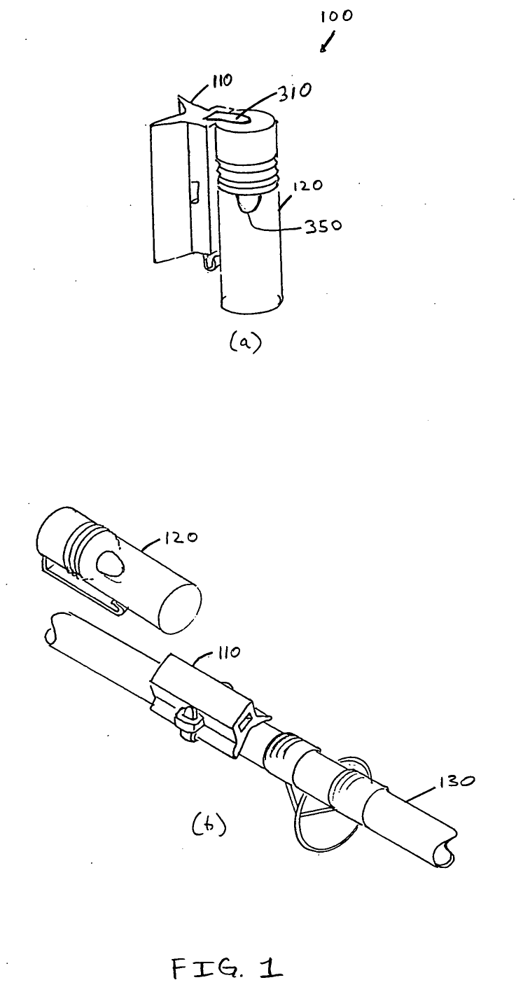

FIG. 1 illustrates a fish strike indicating apparatus 100 according to an exemplary embodiment of the present invention. As shown in image (a) of FIG. 1, the fish strike indicating apparatus 100 includes a fishing rod mount 110 and a fish strike indicator 120. The fish strike indicator 120, hereinafter referred to as the indicating unit, is connected to the fishing rod mount 110, hereinafter referred to as the mounting unit, via a clip 310.

As further shown in FIG. 1, the indicating unit 120 includes a motion activated light emitting element 350. Thus, when the fish strike indicating apparatus 100 is connected to a fishing rod 130 as shown in image (b), upon movement of the fishing rod 130, such as that which occurs when a fish strikes a baited line, the light emitting element 350 illuminates, thereby providing a visual indication to a fisherman that a fish has struck. This can be particularly useful to a night-fisherman as visually minding a fishing rod at night can be difficult.

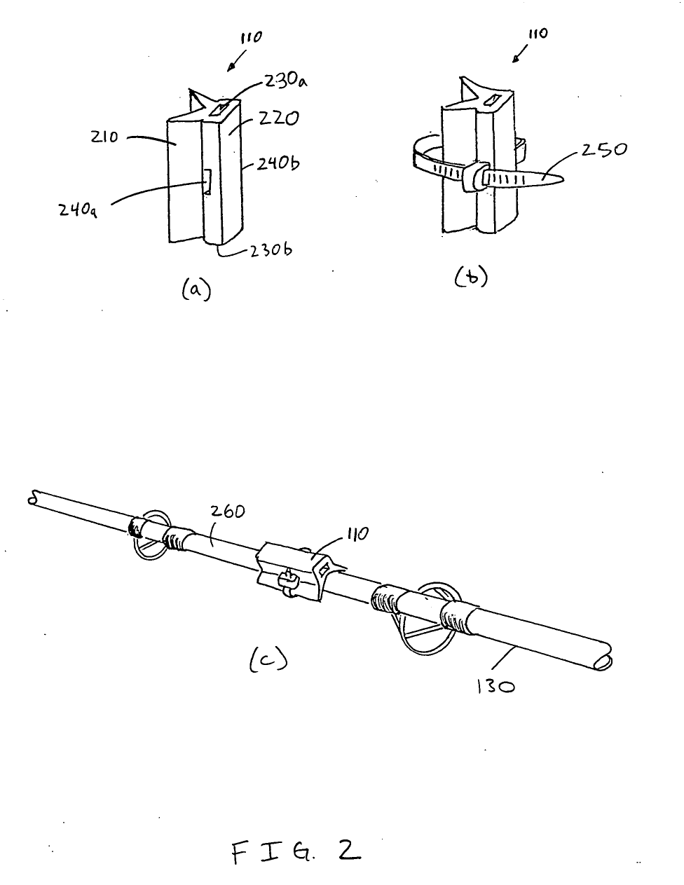

Referring now to images (a-c) of FIG. 2, the mounting unit 110 includes a first portion 210 and a second portion 220. The first portion 210 is configured to have a concave or U-like shape such that it is contoured to fit to a back or top side 260 of the fishing rod 130. The second portion 220 may include a pair of openings 240a and b for receiving a fastener 250, for example, a cable tie, thread or the like, such that the mounting unit 110 can be secured to the fishing rod 130.

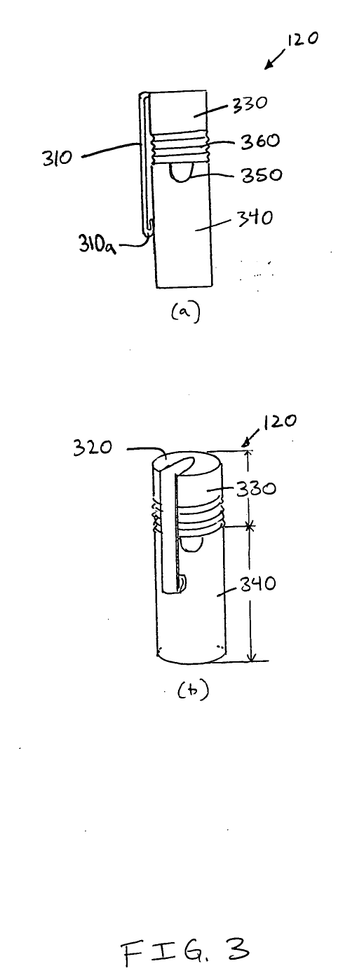

The second portion 220 may further include an elongated cavity insert having first and second openings 230a and b. The elongated cavity insert is configured such that it may receive the clip 310 of the indicating unit 120. For example, the cavity insert may receive the clip 310 via the first opening 230a and the clip 310 may extend through the cavity and out the second opening 230b. In order for the clip 130 to be secured in the cavity, it may have a thickness such that it fits snug in the cavity and is thus not capable of being removed without a certain amount of force applied thereto. Further, the clip 310 may include a hooked potion 310a (as shown in FIG. 3) such that it can be hooked around, for example, a bottom side of the second portion 220. The clip 310 may then be removed by pressing the hooked portion 310a such that it fits into the second opening 230b and pulling the indicating unit 120 such that the clip 130 exits out the first opening 230a.

Although the cavity insert is shown as having two openings 230a and b, it is to be understood that the cavity insert may have only one opening. Further, the cavity insert may include a locking mechanism such that when the clip 310 is inserted into the cavity it may be locked in place. The clip 310 may then be removed by releasing the locking mechanism by means, for example, of a button located on the mounting unit 110. It is to be understood that the mounting unit 110 can be selectively placed on the back side 260 of the rod 130 to increase or decrease the sensitivity of the indicating apparatus 100. For example, if the mounting unit 110 is positioned near a tip of the fishing rod 130, the sensitivity of the indicating apparatus to motion increases and if the mounting unit 110 is positioned near a reel on the fishing rod 130, the sensitivity of the indicating apparatus to motion decreases.

In addition, the mounting unit 110 may be mounted to the back side 260 of the fishing rod 130 before or after a fishing line has been cast. Further, the indicating unit 120 may be coupled to the mounting unit 110 before or after the line has been cast; however, it is preferable to couple the indicating unit 120 to the mounting unit 110 after the line has been cast and the fishing rod 130 has been positioned upright in a sand spike or in some other rod holding means or position. The mounting unit 110 may be formed of silicon or plastic.

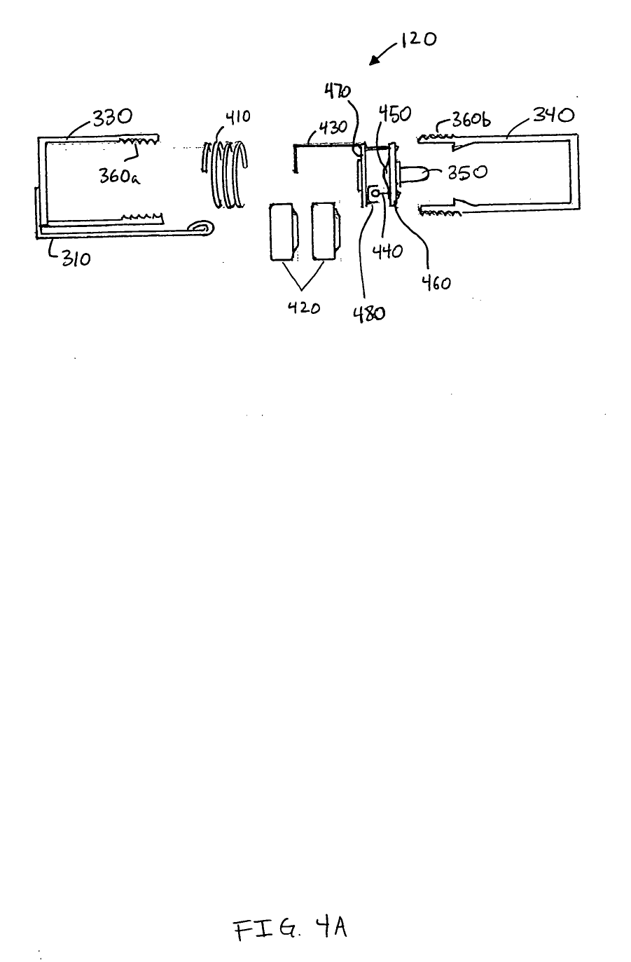

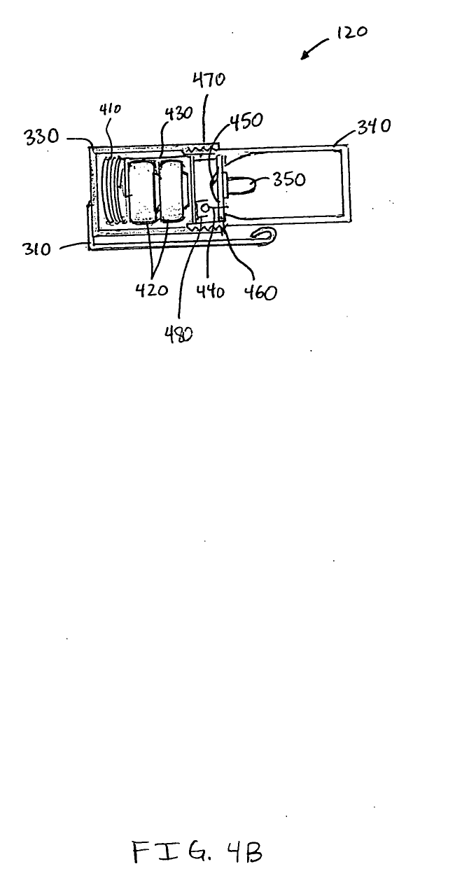

Referring now to images (a and b) of FIG. 3, the indicating unit 120 includes a housing 320 including a first portion 330 and a second portion 340. The first portion 330 may be connected via threaded sections 360a and b (shown in FIG. 4A) of the first and second potions 330 and 340. The threaded section 360a of the first portion 330 may be a male threaded section and the threaded section 360b of the second portion 340 may be a female threaded portion or vice versa. It is to be understood that the first and second portions 330 and 340 may also be connected to each other by using a male insert section of the first portion 330 and a female receiving section of the second portion 340 or vice versa.

Although the housing 320 of the indicating unit 120 has been shown as being cylindrical the housing 320 may be formed of any shape suitable for use with the mounting unit 110. Also, the clip 310 may be integrally formed with the housing 320. Moreover, the second portion 340 of the housing 320 may be a clear plastic diffuser that enables light emitted by the light emitting element 350 to be observed. The diffuser may be colored. The light emitting element 350 may also be colored.

As further shown in FIG. 3, the indicating unit 120 includes the light emitting element 350. The light emitting element 350 may be, for example, a light emitting diode (LED), an organic light emitting diode (OLED) or a light bulb that is illuminated in response to movement. A more detailed description of the indicating unit 120 and the circuitry used for illuminating the light emitting element 350 will now be described with reference to FIGS. 4A and 4B.

As shown in FIG. 4A, the indicating unit 120 includes an indicating circuit, the indicating circuit including a spring 410, a power source 420 such as a battery or a pair of batteries, a metal strip 430, a contact switch 440 such as a spring located in a channel 480, a timing circuit 450, a printed circuit board 460, a circuit unit 470 and the light emitting element 350.

The power source 420 is connected at one end between the spring 410 and a portion of the metal strip 430 and at another end to a bottom side of the circuit unit 470. The circuit unit 470 includes the contact switch 440 and the printed circuit board 460, with the metal strip 430 connected to a bottom portion thereof. The printed circuit board 460 includes the light emitting element 350 and the timing circuit 450 coupled thereto.

The indicating circuit is motion sensitive such that when it is moved, the contact switch 440 touches the channel 480 and closes the indicating circuit, thereby causing the light emitting element 350 to be energized and thus illuminated by the power source 420. Once the power provided by the power source 420 has dissipated, the light emitting element 350 stops being illuminated.

Although the contact switch 440 typically determines an amount of time the light emitting element 350 is illuminated, the timing circuit 450 may be used to adjust the illumination time. For example, indicating unit 120 may include an adjustable knob connected to the timing circuit 450 or the timing circuit 450 may be programmed to increase or decrease the amount of time the light emitting element 350 is illuminated. Further, the light emitting element 350 may be illuminated either continuously or discontinuously in response to movement of the fishing rod 130. For example, as the switch 440 periodically touches the channel 480 when vibrated, the light emitting element 350 will be discontinuously illuminated. In other words, the light emitting element 350 will flash.

Although the indicating circuit includes a variety of elements such as the spring 410 for securing the components of the circuit in place or the timing circuit 450 for adjusting the amount of time the light emitting element 350 is to be illuminated, it is to be understood that the indicating circuit may be constructed in some embodiments with or without these or other components. Further, the indicating circuit may be any of a variety of motion indicating circuits such as, for example, those disclosed in U.S. Pat. No. 6,467,939, a copy of which is incorporated by reference herein in its entirety.

FIG. 4B illustrates the location of the indicating circuit in the indicating unit 120. As shown in FIG. 4B, the indicating circuit can be located solely in the first portion 330 of the indicating unit 120 with the light emitting element 350 protruding into the second portion 340 of the indicating unit 120.

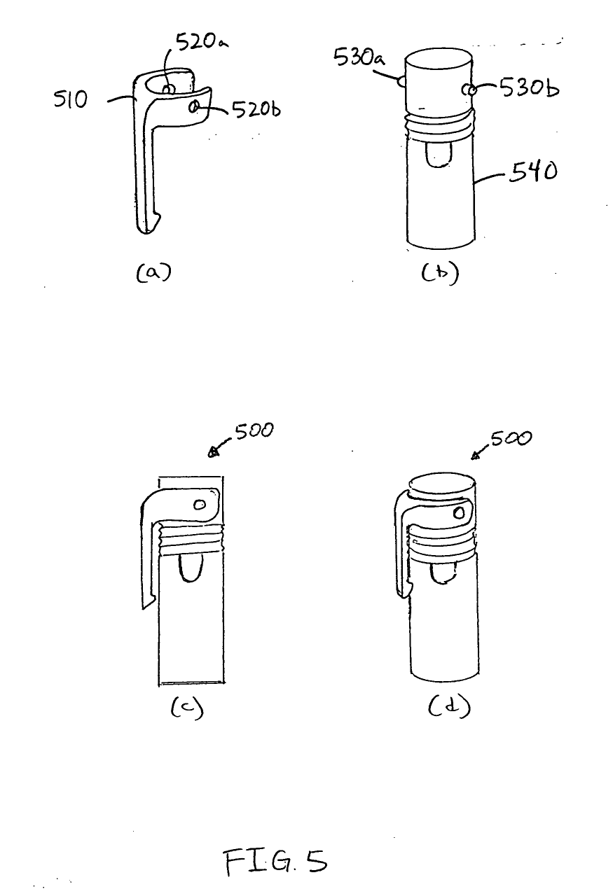

FIG. 5 illustrates another exemplary embodiment of an indicating unit 500. A clip 510 having a pair of opening 520a and 520b is shown in image (a) and a housing portion 540 of the indicating unit 500 having a pair of protruding portions 530a and 530a is shown in image (b). As shown in images (c and d), the openings 520a and 520b may be used to secure the clip 510 to the housing portion 540 via the protruding portions 530a and 530b.

It should be understood that the above description is only representative of illustrative embodiments. For the convenience of the reader, the above description has focused on a representative sample of possible embodiments, a sample that is illustrative of the principles of the invention. The description has not attempted to exhaustively enumerate all possible variations. That alternative embodiments may not have been presented for a specific portion of the invention, or that further undescribed alternatives may be available for a portion, is not to be considered a disclaimer of those alternate embodiments. Other applications and embodiments can be implemented without departing from the spirit and scope of the present invention. It is therefore intended, that the invention not be limited to the specifically described embodiments, because numerous permutations and combinations of the above and implementations involving non-inventive substitutions for the above can be created, but the invention is to be defined in accordance with the claims that follow. It can be appreciated that many of those undescribed embodiments are within the literal scope of the following claims, and that others are equivalent.

What is claimed is:

1. A fish strike indicating apparatus, comprising:
a mounting unit for mounting on a fishing rod, the mounting unit including a first portion having a concave configuration, and a second portion having an elongated cavity insert; and
an indicating unit for indicating movement of the fishing rod, the indicating unit including a clip for slidably coupling to the second portion via the elongated cavity insert.

2. The fish strike indicating apparatus of claim 1, further comprising:
a fastener for fastening the mounting unit to the fishing rod.

3. The fish strike indicating apparatus of claim 2, wherein the fastener is a tie.

4. The fish strike indicating apparatus of claim 2, wherein the mounting unit further comprises:
a first opening and a second opening for receiving the fastener.

5. The fish strike indicating apparatus of claim 1, wherein the indicating unit further comprises a housing, the housing comprising:
a battery;
a timer;
a printed circuit; and
a light emitting element.

6. The fish strike indicating apparatus of claim 5, wherein the housing is cylindrical.

7. The fish strike indicating apparatus of claim 5, wherein the clip is affixed to the housing.

8. The fish strike indicating apparatus of claim 5, wherein the light emitting element is an LED, OLED or a light bulb.

9. The fish strike indicating apparatus of claim 5, wherein the housing further comprises a first portion and a second portion, the first portion for storing the battery, timer, printed circuit, and light emitting element, the second portion for displaying light emitted by the light emitting element.

10. The fish strike indicating apparatus of claim 9, wherein the first portion of the housing is coupled to the second portion of the housing via a coupling means.

11. A fish strike indicating apparatus for use with a fishing rod having a baited hook coupled to a fishing line, comprising:
a mounting unit for mounting on the fishing rod, the mounting unit including a first side having a concave configuration for connecting to a back side of the fishing rod, a second side having a cavity insert, and a pair of openings for receiving a fastener for fastening the mounting unit to the fishing rod; and
an indicating unit for indicating movement of the fishing rod, the indicating unit including a clip for connecting to the second side via the cavity insert, and a light source for illuminating in response to movement of the fishing rod.

12. The fish strike indicating apparatus of claim 11, wherein the mounting unit is formed of silicon or plastic.

13. The fish strike indicating apparatus of claim 11, wherein the indicating unit comprises:
a spring connected to a power source, the power source connected to the light source, the light source disposed on a printed circuit board;
a metal strip connected at one end between the spring and the power source and connected at another end to the printed circuit board; and
a switch connected to the printed circuit board, the switch responsive to movement of the fishing rod to energize the light source.

14. The fish strike indicating apparatus of claim 13, wherein the power source is a battery.

15. The fish strike indicating apparatus of claim 11, wherein the light source is an LED, OLED or light bulb.

16. The fish strike indicating apparatus of claim 13, wherein the indicating unit further comprises:
a timing circuit for controlling a rate at which the light bulb is energized, wherein the rate at which the light bulb is energized determines an amount of time the light source is illuminated.

17. The fish strike indicating apparatus of claim 11, wherein when the mounting unit is positioned near a reel on the fishing rod an amount of movement of the fishing rod needed for illuminating the light source is greater than an amount of movement of the fishing rod needed for illuminating the light source when the mounting unit is positioned near a tip of the fishing rod.

18. An apparatus for indicating movement of a fishing rod, comprising:
a mount for mounting on the fishing rod, the mount including a first portion contoured to fit to a top side of the fishing rod, and a second portion having a receptacle; and
an indicator for indicating movement of the fishing rod, the indicator including a removable clip for connecting the indicator to the second portion via the receptacle.

19. The motion indicating apparatus of claim 18, wherein the indicator further comprises a light emitting element.

20. The motion indicating apparatus of claim 19, wherein the light emitting element emits light for a predetermined amount of time in response to movement of the fishing rod.
